(19) United States
(12) Patent Application Publication
(10) Pub. No.: US 2006/0028136 A1
(43) Pub. Date: Feb. 9, 2006

(54) Phosphor, and fluorescent lamp and plasma display panel employing the same

(75) Inventors: Xiaoqing Zeng, Gyeonggi-do (KR); Hyoung-bin Park, Gyeonggi-do (KR); Young-mo Kim, Gyeonggi-do (KR); Gi-young Kim, Gyeonggi-do (KR); Sang-hun Jang, Gyeonggi-do (KR); Hidekazu Hatanaka, Gyeonggi-do (KR); Seong-eui Lee, Gyeonggi-do (KR); Seung-hyun Son, Gyeonggi-do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SAMSUNG CORNING CO., LTD., Gyeonggi-do (KR)

(21) Appl. No.: 11/084,774

(22) Filed: Mar. 21, 2005

(30) Foreign Application Priority Data
Aug. 4, 2004 (KR) 10-2004-0061418

(51) Int. Cl. H01J 17/49

(52) U.S. Cl. 313/582

(57) ABSTRACT

There is provided a borate phosphor having the following formula I: (Y_{1-x-y-z}GdₓQ_{y}Bi_{z})BO₃ wherein: Q is Eu or Tb; 0≦x<1; 0<y≦0.2; and 0≦z<0.1. The borate phosphor has a good luminescent characteristic and color purity. A fluorescent lamp and the PDP with improved luminance and/or color gamut is obtained by employing the phosphor.

### BACKGROUND OF THE INVENTION

Priority is claimed to Korean Patent Application No.10-2004-0061418, filed on Aug. 4, 2004, in the Korean Intellectual Property Office, the disclosure of which is incorporated herein in its entirety by reference.

1. Field of the Invention

The present invention relates to a phosphor, and more particularly, to red and green phosphors having a good luminescent characteristic and good color purity, in which the phosphor may be applied to a fluorescent lamp and a plasma display panel (PDP).

2. Description of the Related Art

A phosphor emits light when stimulated by, for example, energy, and is generally used in a light source (e.g., a mercury fluorescent lamp, a mercury-free fluorescent lamp, etc) and various devices (e.g., a field emission display, a plasma display panel, etc.). Also, it is predicted that the phosphor may be used for various uses along with development of multimedia appliances.

The phosphor employed in the light source or device has to be selected such that it absorbs excitation light of wavelength generated from the light source or device and is excited. Also, the phosphor should have physical properties, such as current saturation characteristic, deterioration characteristic, luminescent characteristic, color purity, etc., suitable for the use of each light source or device.

The mercury-free florescent lamp or PDP renders the phosphor to excite in excitation light (its pick at 172 nm) of vacuum ultraviolet (VUV) wavelength of about 147 nm to about 200 nm by use of a discharge gas, for example, xenon. Examples of the phosphor are disclosed by Korean Unexamined Patent Nos. 2001-0017535 (borate phosphor represented by formula (Y,Gd)BO₃:Eu) and 2001-0010166 (borate phosphor represented by formula (Y,Tb):BO₃).

The borate phosphors have a good excitation characteristic relative to a wavelength of about 147 nm to about 172 nm, but have relatively poor excitation characteristics relative to a wavelength of about 172 nm to about 200 nm.

### SUMMARY OF THE INVENTION

Embodiments of the present invention provide a phosphor having a good luminescent characteristic and good color purity and a fluorescent lamp and PDP employing the same.

According to an aspect of the present invention, there is provided borate phosphor having the following formula I: (Y_{1-x-y-z}GdₓQ_{y}Bi_{z})BO₃, wherein: Q is Eu or Tb; 0≦x<1; 0<y≦0.2; and 0≦z≦0.1

According to another aspect of the present invention, there is provided a fluorescent lamp comprising: a front substrate; a rear substrate having a plurality of discharge electrodes and a dielectric layer covering the discharge electrode; a spacer for providing a desired interval between the front substrate and the rear substrate to form a discharge space; a discharge gas existed in the discharge space; and a phosphor layer provided at least one side of the front and rear substrates, in which the phosphor layer includes a borate phosphor having the following formula I:
(Y_{1-x-y-z}GdₓQ_{y}Bi_{z})BO₃, wherein: Q is Eu or Tb; 0≦x<1; 0<y≦0.2; and 0≦z≦0.1.

According to still another aspect of the present invention, there is provided a plasma display panel comprising: a front substrate; a rear substrate arranged in parallel on the front substrate; a barrier rib located between the front substrate and the rear substrate for dividing a plurality of light emitting cells; address electrodes extended along the light emitting cells arranged in one direction, and buried by a rear dielectric layer; pairs of sustain electrodes extended in a direction crossing an extended direction of the address electrode, and buried by a front sustain dielectric layer; a phosphor layer applied on an internal surface of the barrier rib; and a discharge gas contained in the light emitting cells, in which the phosphor comprises a borate phosphor having the following formula I: (Y_{1-x-y-z}GdₓQ_{y}Bi_{z})BO₃, wherein: Q is Eu or Tb; 0≦x<1; 0<y≦0.2; and 0≦z≦O.1.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a fluorescent lamp according to an embodiment of the present invention;

FIG. 2 is a cross-sectional view of a PDP according to an embodiment of the present invention;

FIG. 3 is a graph showing an XRD pattern of a borate phosphor according to an embodiment of the present invention;

FIGS. 4 through 6 are graphs showing excitation characteristic of a borate phosphor according to embodiments of the present invention;

FIGS. 7 through 10 are graphs showing luminescent characteristic of a borate phosphor according to embodiments of the present invention;

FIG. 11 is a color coordinate showing color purity of a borate phosphor according to an embodiment of the present invention; and

FIG. 12 is a color coordinate showing a color gamut of a fluorescent lamp employing a borate phosphor according to an embodiment of the present invention.

### DETAILED DESCRIPTION OF THE INVENTION

The present invention will now be described in detail with reference to embodiments.

A borate phosphor of the present invention has the following formula I:
(Y_{1-x-y-z}GdₓQ_{y}Bi_{z})BO₃

wherein: Q is Eu or Tb; 0≦x<1; 0<y≦0.2; and 023 z≦0.1.

In the above formula I, Q appears to serve as an activator to emit light in absorbing or radiating energy through transition between a ground level and an excitation level of element ions (e.g., Eu³⁺ ions, Tb³⁺ ions, etc.) indicated by Q. A regulated by the Q to emit the light in various colors, e.g., red, green, blue, etc.

In the above formula I, Bi appears to serve as a sensitizer. The sensitizer itself does not absorb or radiate the light, but improves a luminous efficiency of the activator. Although is not based on certain theories, it is well known that the sensitizer increases crystallization of host material among the phosphor, or improves conductivity of the host material, which increases an efficiency of energy transfer from the host material to the activator or doping efficiency of the activator to improve the luminous efficiency. If the sensitizer itself, Bi, emits in an unwanted wavelength, it may serve as a luminescence killer. Therefore, a small fraction of Bi is preferably provided. In view of the above matter, the borate phosphor of the present invention preferably contains up to 0.1 mol% of Bi.

More specifically, the borate phosphor of the formula I may comprise the following formula II:
(Y_{1-x-y-z}GdₓEu_{y}Bi_{z})BO₃

wherein: 0≦x≦0.4; 0<y≦0.1; and 023 z≦0.1.

The borate phosphor having the formula II may be utilized as a red phosphor. Typical examples of the borate phosphor having the formula II include
(Y_{0.935}Eu_{0.05}Bi_{0.015})BO₃ phosphor, (Y_{0.645}Gd_{0.3}Eu_{0.05}Bi_{0.005})BO₃ phosphor, (Y_{0.64}Gd_{0.3}Eu_{0.05}Bi_{0.01})BO₃ phosphor, etc.

Also, the borate phosphor of the formula I may comprise the following formula III:
(Y_{1-x-y-z}GdₓTb_{y}Bi_{z})BO₃

wherein: 0≦x<1; 0<y≦0.2; and 0≦z≦0.1.

The borate phosphor having the formula III may be utilized as a green phosphor. Typical examples of the borate phosphor having the formula III include
(Y_{0.93}Tb_{0.06}Bi_{0.01})BO₃ phosphor, (Y_{0.514}Gd_{0.4}Tb_{0.08}Bi_{0.006})BO₃ phosphor, (Y_{0.51}Gd_{0.4}Tb_{0.08}Bi_{0.01})BO₃ phosphor, etc.

The borate phosphor embodiment of the present invention has a good luminescent characteristic and good color purity relative to the excitation light of VUV wavelength, which will be described hereinafter with reference to the following embodiments.

In order to regulate a mole ratio of the borate phosphor, sources of elements each having a stoichiometrically regulated content are mixed, and then the mixture is heat-treated. If necessary, a source of BO₃ may be used in an amount exceeding the stoichiometrically regulated content. Oxides or hydrates of various elements forming the phosphor may be used as the source of each element. Specifically, Y₂O₃ may be used as a source of Y, Gd₂O₃ as a source of Gd, Tb₄O₇, Tb₂(CO₃)₃.xH₂O or TbCl₃.xH₂O as a source Tb, Eu₂O₃ as a source of Eu, and Bi₂O₃ as a source of Bi, but the present invention is not restricted thereto. Meanwhile, B₂O₃ or H₃BO₃ may be used as a source of BO₃.

As described above, after the sources of elements are mixed, the mixture is heat-treated to produce the phosphor. A method of heat-treating the mixture may consist of a single stage or multiple stages comprising two stages. When the heat treatment is carried out, a temperature may be determined by a temperature analyzing method, e.g., TGA and/or DTA, relative to the source of element forming the phosphor.

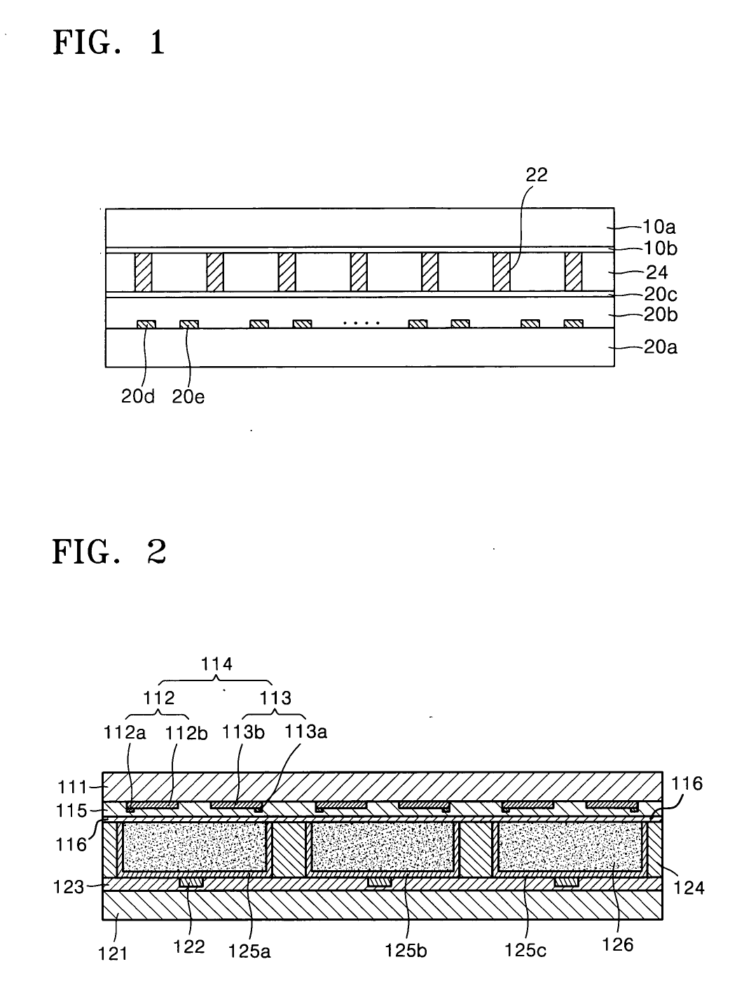

The phosphor of the present invention may be used in a common fluorescent lamp. In particular, a flat fluorescent lamp is utilized as a backlight unit for an LCD. The flat fluorescent lamp of embodiments of the present invention includes a front substrate, a rear substrate having a plurality of discharge electrodes and a dielectric layer covering the discharge electrode, a spacer for providing a desired interval between the front substrate and the rear substrate to form a discharge space, a discharge gas existed in the discharge space, and a phosphor layer provided at least one side of the front and rear substrates. The phosphor layer includes the phosphor having the formula I. Specifically, a reference will now be made to FIG. 1 to describe the flat fluorescent lamp of embodiments of the present invention.

Referring to FIG. 1, a front substrate 10a is provided on one surface thereof with a first phosphor layer 10b. A rear substrate 20a is provided on one surface thereof with a rear dielectric layer 20b and a second phosphor layer 20c in turn. A plurality of discharge electrodes 20d and 20e arranged in a stripe shape are provided between the rear substrate 20a and the rear dielectric layer 20b. A discharge space 24 is formed between the front substrate 11a and the rear substrate 20a by spacers 22. The discharge space is filled with a discharge gas, comprising at least one selected from the group consisting of hydrogen, argon, neon, xenon and mercury.

If the discharge electrodes 20d and 20e are applied with a drive voltage of above discharge operating voltage, a discharge is created between a pair of electrodes. Hot electrons are generated in the discharge space 24 by the discharge, and thus the discharge gas within the discharge space 24 is excited by the hot electrons. At this time, a non-Hg discharge gas, such as Xe, generates the excitation light having a wavelength of about 147 nm to about 200 nm, and an Hg discharge gas generates the excitation light having a wavelength of about 254 nm. Since the borate phosphor of the present invention has a good excitation light in a wavelength of about 147 nm to about 200 nm and a wavelength of about 254 nm, it can be effectively applied to a mercury fluorescent lamps and mercury-free fluorescent lamps.

At least one of the first and second phosphor layers 10b and 20c includes the phosphor represented by the formula I. The phosphor contained in the first phosphor layer 10b may be identical to or different from that contained in the second phosphor layer 20c.

According to one embodiment of the phosphor used in the phosphor layer of the fluorescent lamp of the present invention, the first and second phosphor layers 10b and 20c can use the borate phosphor having the formula II as the red phosphor, at and 20c can use the borate phosphor having the formula II as the red phosphor, at ZnGa₂O₄:Mn phosphor and Zn₂SiO₄:Mn phosphor as the green phosphor, and at least one of BaMgAl₁₀O₁₇:Eu phosphor, BaMgAl₁₄O₂₃:Eu phosphor and BaMg₂Al₁₆O₂₇:Eu as the blue phosphor. The fluorescent lamp using the combination of the above phosphors has a high luminescent efficiency.

According to another embodiment of the phosphor used in the phosphor layer of the fluorescent lamp of the present invention, the first phosphor layer 10b can use Y(PV)O₄:Eu phosphor as the red phosphor, BaMgAl₁₀O₁₇:Eu,Mn phosphor or BaMg₂Al₁₆O₂₇:Eu,Mn phosphor as the green phosphor, and BaMgAl₁₀O₁₇:Eu phosphor as the blue phosphor. The phosphors have good luminescent characteristics in the excitation light of about 320 nm. In addition, the second phosphor layer 20c can use the borate phosphor having the formula II as the red phosphor layer 20c can use the borate phosphor having the formula II as the red BaMgAl₁₀O₁₇:Eu phosphor as the blue phosphor. The red phosphor and green phosphor radiate a red light and a green light, together with ultraviolet rays having a wavelength of about 320 nm, respectively. The fluorescent lamp including the phosphor layer having the phosphor combination provides a good luminescent efficiency and improved color purity.

Phosphors in accordance with the present invention may be applied to a PDP. One embodiment of the PDP including a front panel and a rear panel will now be described with reference to FIG. 2. Referring to FIG. 2, the front panel includes a front substrate 111, pairs of sustain electrodes 114 with a Y electrode 112 and an X electrode 113 formed on the front substrate 111, a front dielectric layer 115 covering the pairs of sustain electrodes 115, and a protective layer 116 covering the front dielectric layer. The Y electrode 112 and the X electrode 113 include transparent electrodes 112b and 113b formed of ITO etc, and bus electrodes 112a and 113a formed of a metal having a good conductivity, respectively.

The rear panel includes a rear substrate 121, address electrodes 122 formed on a front surface of the rear substrate and crossing the sustain electrodes, a rear dielectric layer 123 covering the address electrodes, a barrier rib 124 formed on the rear dielectric layer and dividing light emitting cells 126, and red, green and blue phosphor layers 125a, 125b and 125c located in the light emitting cell. At least one of the red and green phosphor layers includes the borate phosphor having the formula I. Since the borate phosphor having the formula I is described in detail hereinbefore, the detailed description thereof will be omitted. A discharge space divided by the barrier rib is filled with a discharge gas.

The PDP is classified into a direct type, an alternate type and a hybrid type, depending upon an operation method. Also, the PDP is provided with at least two electrodes or at least three electrodes, which are required for the discharge, depending upon the electrode structure. For the direct type, an auxiliary electrode is provided to induce auxiliary discharge. For the alternate type, an address electrode is provided to divide an address discharge and the sustain discharge and thereby improve an address speed. Also, the alternate type is classified into an opposite discharge-type electrode structure and a surface discharge electrode structure. For the opposite discharge-type electrode structure, two sustain electrodes creating the discharge are located on the substrates, respectively, to produce the discharge around a vertical axis. For the surface discharge electrode structure, two sustain electrode creating the discharge are located on the same substrate to produce the discharge on one surface of the substrate. Of course, all of the above types can be applied to the PDP of the present invention.

Reference will now be made to embodiments to describe the present invention.

### Embodiments

### Embodiment 1

Production of (Y_{0.935}Eu_{0.05}Bi_{0.015})BO₃ phosphor:

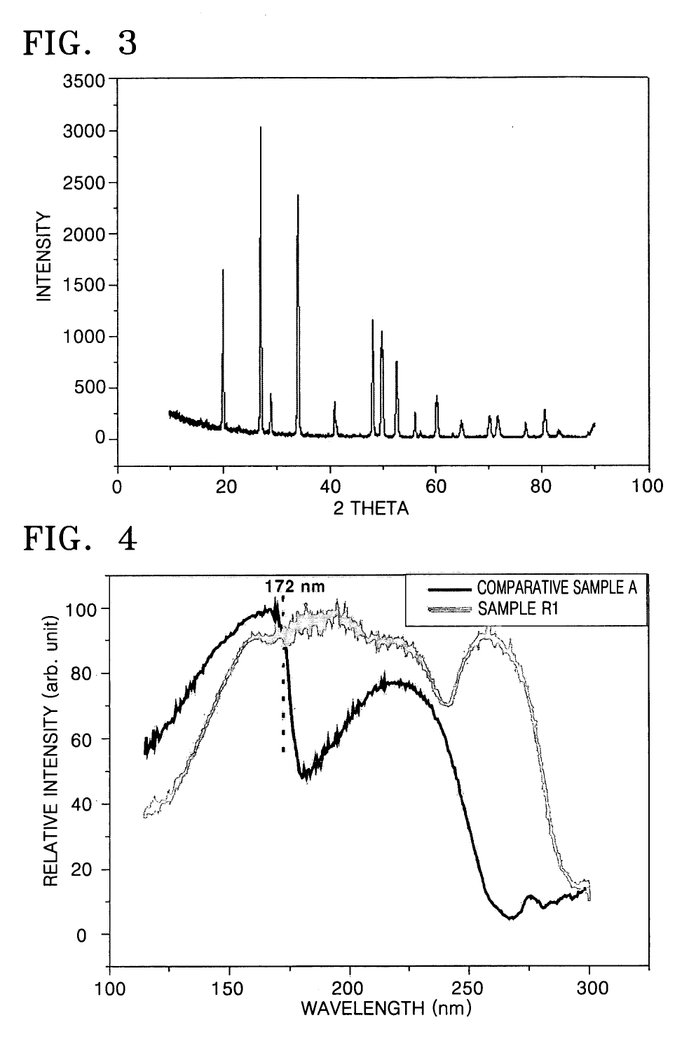

A borate phosphor was made so that a mole ratio of each element is Y:Eu:Bi=0.935:0.05:0.15. In order to confirm to the mole ratio, 7.92 grams of Y₂O₃ as a source of Y, 0.66 grams of Eu₂O₃ as a source of Eu, and 0.262 grams of Bi₂O₃ as a source of Bi were mixed and milled, and then were added with 5.12 grams of H₃BO₃ and agitated during 5 hours. The mixture was heat-treated at a temperature of 1100° C. during 4 hours under the atmosphere, and then was cleaned and dried by means of deionized water. As a result of analyzing the substance by using an XRD analyzing apparatus (Philps pro-MPD; trademark), YBO₃ was obtained. A pattern of the XRD is shown in FIG. 3, and the substance is referred to as a sample R1.

### Embodiment 2

Production of (Y_{0.645}Gd_{0.3}Eu_{0.05}Bi_{0.005})BO₃ phosphor:

A borate phosphor was made so that a mole ratio of each element is Y:Gd:Eu:Bi=0.645:0.3:0.05:0.005. The same method as that of the embodiment 1 was carried out, except for using a mixture consisting of 5.45 grams of Y₂O₃, 4.08 grams of Gd₂O₃, 0.66 grams of Eu₂O₃, 0.087 grams of Bi₂O₃, and 5.56 grams of H₃BO₃. The substance was analyzed by using an XRD analyzing apparatus (Philps pro-MPD; trademark). The analyzed result is shown in FIG. 3, and the substance is referred to as a sample R2.

### Embodiment 3

Production of (Y_{0.64}Gd_{0.3}Eu_{0.05}Bi_{0.01})BO₃ phosphor:

A borate phosphor was made so that a mole ratio of each element is Y:Gd:Eu:Bi=0.64:0.3:0.05:0.01. The same method as that of the embodiment 1 was carried out, except for using a mixture consisting of 5.41 grams of Y₂O₃, 4.08 grams of Gd₂O₃, 0.66 grams of Eu₂O₃, 0.175 grams of Bi₂O₃, and 5.56 grams of H₃BO₃. The substance was analyzed by using an XRD analyzing apparatus (Philps pro-MPD; trademark). The analyzed result is shown in FIG. 3, and the substance is referred to as a sample R3.

### Embodiment 4

Production of (Y_{0.93}Tb_{0.06}Bi_{0.01})BO₃ phosphor:

A borate phosphor was made so that a mole ratio of each element is Y:Tb:Bi=0.93:0.06:0.01. In order to confirm to the mole ratio, 7.88 grams of Y₂O₃ as a source of Y, 1.28 grams of Tb₂(CO₃)₃.4H₂O as a source of Tb, and 0.175 grams of Bi₂O₃ as a source of Bi were mixed and milled, and then were added with 5.56 grams of H₃BO₃ and agitated during 5 hours. The mixture was heat-treated at a temperature of 1100° C during 4 hours under the atmosphere, and then was cleaned and dried by means of deionized water. The substance was analyzed by using an XRD analyzing apparatus (Philps pro-MPD; trademark). The analyzed result is shown in FIG. 3, and the substance is referred to as a sample G1.

### Embodiment 5

Production of (Y_{0.514}Gd_{0.4}Tb_{0.08}Bi_{0.006})BO₃ phosphor:

A borate phosphor was made so that a mole ratio of each element is Y:Gd:Tb:Bi=0.514:0.4:0.08:0.006. The same method as that of the embodiment 4 was carried out, except for using a mixture consisting of 4.355 grams of Y₂O₃, 5.44 grams of Gd₂O₃, 1.6 grams of Tb₂(CO₃)₃.4H₂O, 0.105 grams of Bi₂O₃, and 5.56 grams of H₃BO₃. The substance was analyzed by using an XRD analyzing apparatus (Philps pro-MPD; trademark). The analyzed result is shown in FIG. 3, and the substance is referred to as a sample G2.

### Embodiment 6

Production of (Y_{0.51}Gd_{0.4}Tb_{0.08}Bi_{0.01})BO₃ phosphor:

A borate phosphor was made so that a mole ratio of each element is Y:Gd:Tb:Bi=0.51:0.4:0.08:0.01. The same method as that of the embodiment 4 was carried out, except for using a mixture consisting of 4.32 grams of Y₂O₃, 5.44 grams of Gd₂O₃, 1.6 grams of Tb₂(CO₃)₃.4H₂O, 0.175 grams of Bi₂O₃, and 5.56 grams of H₃BO₃. The substance was analyzed by using an XRD analyzing apparatus (Philps pro-MPD; trademark). The analyzed result is shown in FIG. 3, and the substance is referred to as a sample G3.

Formulas of samples of the embodiments 1 through 6 and formulas of comparative samples A through E used in the below test samples are summarized in the following Table 1:

TABLE 1

| Sample No. | Formula |
|---|---|
| Sample R1 | (Y_{0.935}Eu_{0.05}Bi_{0.015})BO₃ |
| Sample R2 | (Y_{0.645}Gd_{0.3}Eu_{0.05}Bi_{0.005})BO₃ |
| Sample R3 | (Y_{0.64}Gd_{0.3}Eu_{0.05}Bi_{0.01})BO₃ |
| Sample G1 | (Y_{0.93}Tb_{0.06}Bi_{0.01})BO₃ |
| Sample G2 | (Y_{0.514}Gd_{0.4}Tb_{0.08}Bi_{0.006})BO₃ |
| Sample G3 | (Y_{0.51}Gd_{0.4}Tb_{0.08}Bi_{0.01})BO₃ |
| Comparative | (Y, Gd)BO₃: Eu phosphor commercially available |
| Sample A | from KASEI |
| Comparative | (Y_{0.65}Gd_{0.3}Eu_{0.05})BO₃ phosphor |
| Sample B | |
| Comparative | (Y_{0.52}Gd_{0.4}Tb_{0.08})BO₃ phosphor |
| Sample C | |
| Comparative | (Y_{0.94}Tb_{0.06})BO₃ phosphor |
| Sample D | |
| Comparative | LaPO₄: Ce, Tb phosphor commercially available |
| Sample E | from KASEI |

Test 1—Test of Excitation Characteristic

Excitation characteristic of the samples R1, R2, R3, G2 and G3 were tested and shown in FIGS. 4 through 6, respectively. The test of the excitation characteristic was carried out through a VUV spectrophotometer operated under a pressure of 1.5×10⁻⁵ torr. Excitation intensity was calibrated on the basis of the excitation characteristic of sodium salicylate.

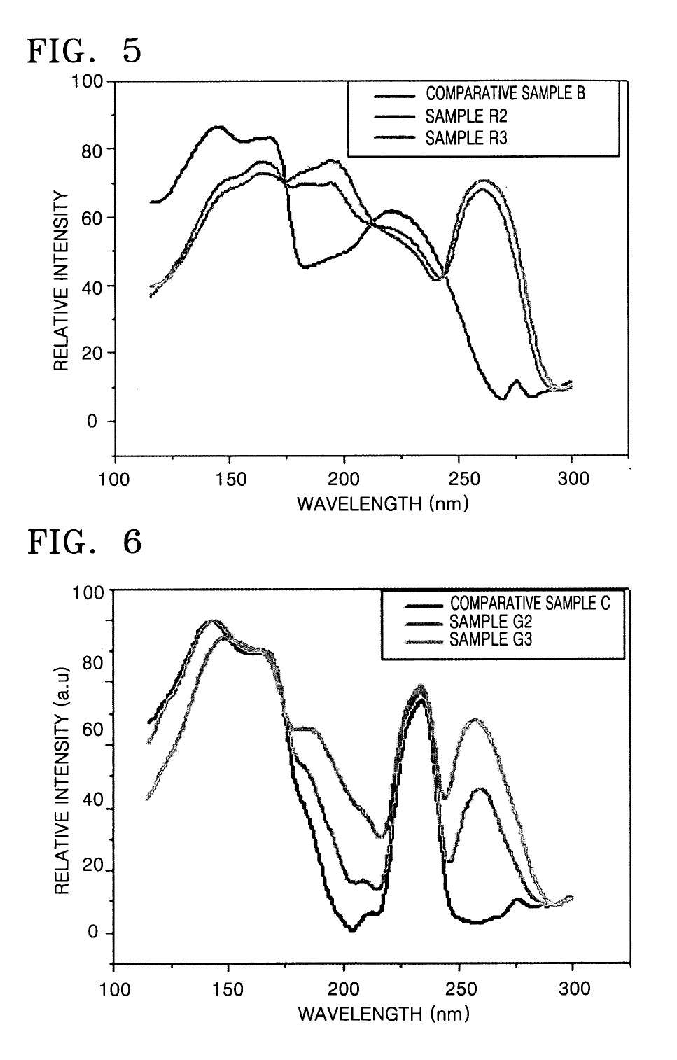

FIG. 4 shows the excitation characteristic of the sample R1 and the excitation characteristic of the comparative sample A. FIG. 5 shows the excitation characteristics of the samples R2 and R3 and the excitation characteristic of the comparative sample B. It would be understood from FIGS. 4 and 5 that the samples R1, R2 and R3 have a very high light absorption in a wavelength of about 170 nm to about 200 nm and a wavelength of about 240 nm to about 270 nm, over the comparative samples A and B. The samples R1, R2 and R3 have a high light absorption in a wavelength of about 140 nm to about 170 nm as good as the comparative samples A and B.

FIG. 6 shows the excitation characteristic of the samples G2 and G3 and the excitation characteristic of the comparative sample C. It would be understood from FIG. 6 that the samples G2 and G3 have a very high light absorption in a wavelength of about 170 nm to about 200 nm and a wavelength of about 240 nm to about 270 nm, over the comparative sample C. The samples G2 and G3 have a high light absorption in a wavelength of about 140 nm to about 170 nm as good as the comparative sample C.

As such, it would be understood that the borate phosphor of the present invention has the excitation characteristic suitable for the excitation light due to the discharge gas contained in the fluorescent lamp and PDP.

Test 2—Test of Luminescent Characteristic

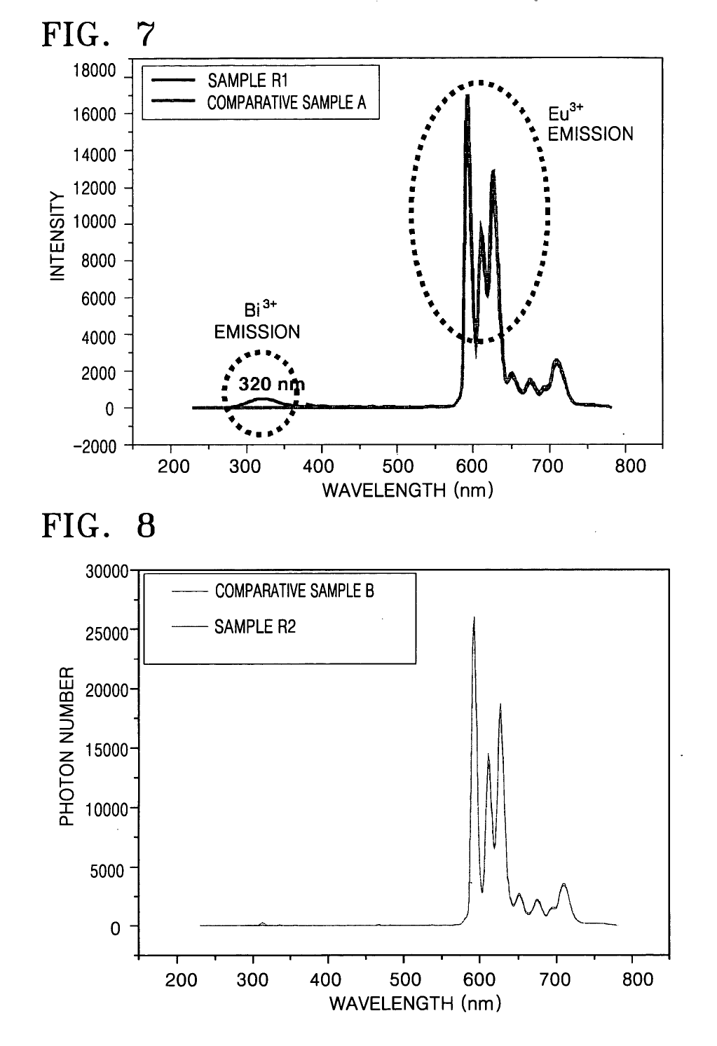

Luminescent characteristic of the samples R1, R2, G1 and G2 were tested and shown in FIGS. 7 through 10, respectively. The test of the luminescent characteristic was carried out through a spectrophotometer having Xe excimer lamp as a light source and operated under a pressure of 30 mtorr and the excitation light of 172 nm.

FIG. 7 shows the luminescent characteristic of the sample R1 and the luminescent characteristic of the comparative sample A. It would be understood from FIG. 7 that for the sample R1 there is luminance of Bi³⁺ in a wavelength of about 320 nm, different from the comparative sample A. The luminance of Eu³⁺ was observed as a peak value in the wavelength of about 593 nm, about 611 nm and about 625 nm.

FIG. 8 shows the luminescent characteristic of the sample R2 and the luminescent characteristic of the comparative sample B. It would be seen from FIG. 8 that a peak value is observed in the wavelength of about 593 nm, about 611 nm and about 625 nm. Bi³⁺ radiation is disappeared in a wavelength of 320 nm, due to the addition of Gd³⁺ ions. Photon number was determined by use of the spectrophotometer.

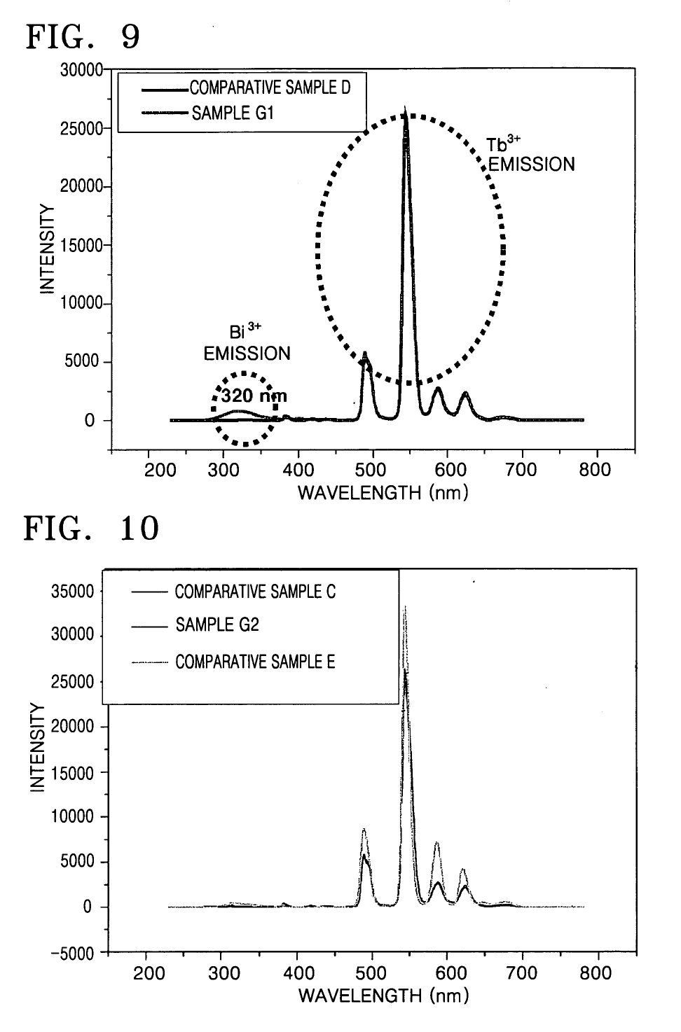

FIG. 9 shows the luminescent characteristic of the sample G1 and the luminescent characteristic of the comparative sample D. It would be understood from FIG. 9 that for the sample G1 there is luminance of Bi³⁺ in a wavelength of about 320 nm, different from the comparative sample D. The luminance of Tb³⁺ was observed as a peak value in the wavelength of about 550 nm.

FIG. 10 shows the luminescent characteristic of the sample G2 and the luminescent characteristic of the comparative samples C and E. It would be understood from FIG. 10 that for the sample G2 has a peak luminance in a wavelength of about 550 nm.

As such, it would be understood that the borate phosphor of the present invention has the luminescent characteristic suitable for the excitation light due to the discharge gas contained in the fluorescent lamp and PDP.

Test 3—Test of Luminance and Color Purity

Luminance and color purity of the samples R2 and G2 were tested and shown in Table 2, respectively. In the Table 2, increased amounts of luminance of the samples R2 and G2 are stated as a ratio of luminance of the samples R2 and G2 to the comparative sample. The test of the luminance and color purity was carried out through a VUV lamp having a wavelength of 172 nm and a spectrophotometer under a pressure of 30 mtorr.

TABLE 2

| | | | Color | Luminance |
|---|---|---|---|---|
| | | Luminance | Impurity | ratio (%) |
| Red | Sample R2 | 70 | (0.64, | sample R2/ |
| Phosphor | Comparative | 67 | 0.358) | comparative |
| | Sample B | | (0.64, | sample B = |
| | | | 0.359) | 104.5% |
| Green | Sample G2 | 105 | (0.327, | sample G2/ |
| Phosphor | Comparative | | 0.612) | comparative |
| | Sample C | 99.9 | (0.323, | sample C = |
| | | | 0.615) | 106% |
| | Comparative | 116.4 | (0.346, | |
| | Sample E | | 0.58) | |

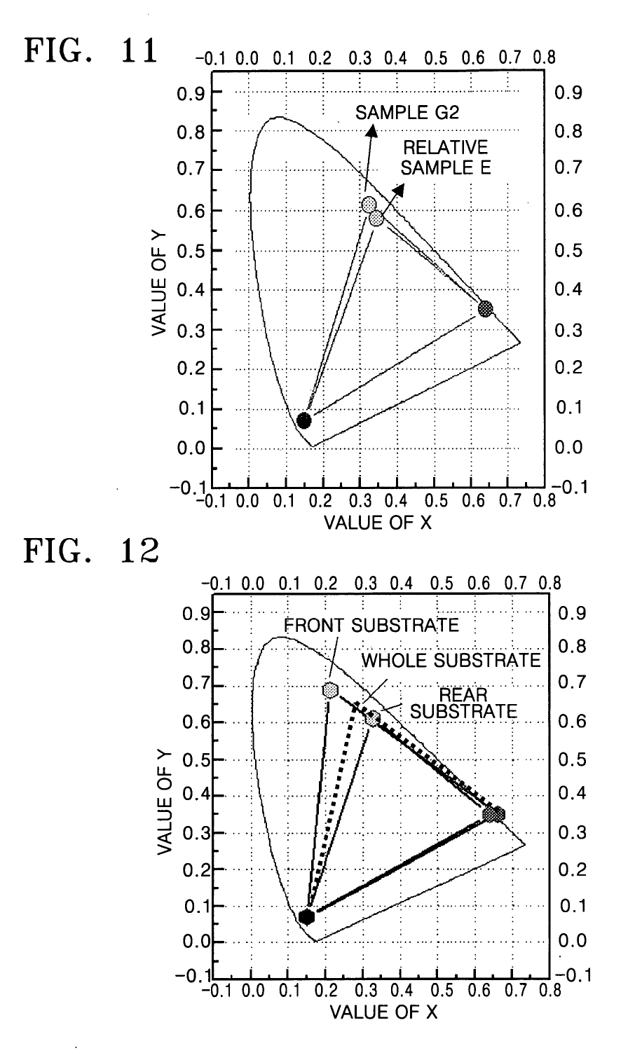

From the above Table 2, it would be understood that the luminance and color purity of the sample R2 are improved over the comparative sample B, the luminance and color purity of the sample G2 are improved over the comparative sample C, and the color purity of the sample G2 are improved over the comparative sample E. In particular, the color purity of the sample G2 is very improved over that of the comparative sample E, which can be seen from a color coordinate graph of FIG. 11.

### PRODUCTION EXAMPLE 1

The production example illustrates a flat fluorescent lamp employing phosphors in accordance with the present invention. First of all, a transparent glass rear substrate and a rear substrate including a dielectric layer, a discharge electrode and a spacer were prepared.

A phosphor paste comprising Y(PV)O₄:Eu phosphor as a red phosphor commercially available from KASEI OPTONIX, Ltd., BaMgAl₁₀O₁₇:Eu,Mn or BaMg₂Al₁₆O₂₇:Eu,Mn phosphor as a green phosphor commercially available from KASEI OPTONIX, Ltd., and BaMgAl₁₀O₁₇:Eu phosphor as a blue phosphor commercially available from KASEI OPTONIX, Ltd. was produced, and after applied on one side of the front substrate, was heat-treated at a temperature 500° C. under the atmosphere during 15 minutes.

A phosphor paste comprising the sample R1 as a red phosphor, the sample G1 as a green phosphor, and BaMgAl₁₀O₁₇:Eu phosphor as a blue phosphor commercially available from KASEI OPTONIX, Ltd. was produced, and after applied on one side of the front substrate, was heat-treated at a temperature 500° C. under the atmosphere during 15 minutes.

A spacer was located between the front substrate and the rear substrate to form a space, and a gas of 5% H₂/95% Xe was introduced into the space. Then, two substrates were sealed to complete the flat fluorescent lamp.

FIG. 12 shows a color gamut of the flat fluorescent lamp. The color gamut was tested through the test of color purity of the test 3. It would be understood from FIG. 12 that the color gamut of the flat fluorescent lamp is superior over that of a conventional lamp.

### PRODUCTION EXAMPLE 2

The production example illustrates a PDP employing the phosphor of the present invention. First of all, a rear substrate including an address electrode, a dielectric layer and a barrier rib was prepared.

A phosphor paste comprising the sample R1, a phosphor paste comprising the sample G1, and a phosphor paste comprising BaMgAl₁₀O₁₇:Eu phosphor commercially available from KASEI OPTONIX, Ltd. were applied on the rear substrate, respectively, to form red, green and blue phosphor layers.

Then, a front substrate having a sustain electrode was prepared, and sealed the rear substrate. A space formed located between the front substrate and the rear substrate was filled with a gas of 5% H₂/95% Xe. The PDP of the present invention represents a superior luminance and color gamut.

With the above description, the phosphor of the present invention has a good excitation characteristic to the excitation light due to the discharge gas contained in the fluorescent lamp and the PDP, thereby improving the luminescent characteristic. In particular, the green phosphor has the good color purity. Accordingly, the fluorescent lamp and the PDP with improved luminance and/or color gamut can be obtained by employing the green phosphor.

While the present invention has been particularly shown and described with reference to exemplary embodiments depicted in the drawings, it will be understood by those of ordinary skill in the art that various changes and modifications in form and details may be made therein without departing from the spirit and scope of the present invention. Therefore, the true spirit and scope for protection of the present invention will be defined by the following claims.

What is claimed is:

1. A borate phosphor having the following formula I:
(Y_{1-x-y-z}GdₓQ_{y}Bi_{z})BO₃
wherein: Q is Eu or Tb; 0≦x<1; 0<y:0.2; and 0≦z≦0.1.

2. The borate phosphor of claim 1, wherein the phosphor is used as a red phosphor, and has the following formula II:
(Y_{1-x-y-z}GdₓEu_{y}Bi_{z})BO₃
wherein: 0≦x≦0.4; 0<y≦0.1; and 0≦z≦0.1.

3. The borate phosphor of claim 1, wherein the phosphor is used as a green phosphor, and has the following formula III:
(Y_{1-x-y-z}GdₓTb_{y}Bi_{z})BO3
wherein: 0≦x<1; 0<y≦0.2; and 0≦z≦0.1.

4. The borate phosphor of claim 1, wherein the phosphor comprises
(Y_{0.935}Eu_{0.05}Bi_{0.015})BO₃, (Y_{0.645}Gd_{0.3}Eu_{0.05}Bi_{0.005})BO₃, and (Y_{0.64}Gd_{0.3}Eu_{0.05}Bi_{0.01})BO₃.

5. The borate phosphor of claim 1, wherein the phosphor comprises
(Y_{0.93}Tb_{0.06}Bi_{0.01})BO₃, (Y_{0.514}Gd_{0.4}Tb_{0.08}Bi_{0.006})BO₃, and (Y_{0.51}Gd_{0.4}Tb_{0.08}Bi_{0.01})BO₃.

6. A fluorescent lamp comprising:
a front substrate;
a rear substrate having a plurality of discharge electrodes and a dielectric layer covering the discharge electrode;
a spacer for providing a desired interval between the front substrate and the rear substrate to form a discharge space;
a discharge gas existed in the discharge space; and
a phosphor layer provided at least one side of the front and rear substrates, in which the phosphor layer includes a borate phosphor having the following formula I:
(Y_{1-x-y-z}GdₓQ_{y}Bi_{z})BO₃
wherein: Q is Eu or Tb; 0≦x<1; 0<y≦0.2; and 0≦z≦0.1.

7. The fluorescent lamp of claim 6, wherein the phosphor layer includes a borate phosphor having the following formula II:
(Y_{1-x-y-z}GdₓEu_{y}Bi_{z})BO₃
wherein: 0≦x≦0.4; 0<y≦0.1; and 0≦z≦0.1.

8. The fluorescent lamp of claim 6, wherein the phosphor layer includes a borate phosphor having the following formula III:
(Y_{1-x-y-z}GdₓTb_{y}Bi_{z})BO₃
wherein: 0≦x<1; 0<y≦0.2; and 0≦z≦0.1.

9. The fluorescent lamp of claim 6, wherein the phosphor layer further comprises at least one of LaPO₄:Ce,Tb phosphor, ZnGa₂O₄:Mn phosphor and Zn₂SiO₄:Mn phosphor as a green phosphor.

10. The fluorescent lamp of claim 6, wherein the phosphor layer further comprises at least one of BaMgAl₁₀O₁₇:Eu phosphor, BaMgAl₁₄O₂₃:Eu phosphor and BaMg₂Al₁₆O₂₇:Eu as a blue phosphor.

11. The fluorescent lamp of claim 6, wherein the discharge gas is selected from any one of hydrogen, argon, neon, xenon, mercury, and a mixture of two or more of hydrogen, argon, neon, xenon. and mercury.

12. A plasma display panel comprising:
a front substrate;
a rear substrate arranged in parallel on the front substrate;
a barrier rib located between the front substrate and the rear substrate for dividing a plurality of light emitting cells;
address electrodes extended along the light emitting cells arranged in one direction, and buried by a rear dielectric layer;
pairs of sustain electrodes extended in a direction crossing an extended direction of the address electrode, and buried by a front sustain dielectric layer;
a phosphor layer applied on an internal surface of the barrier rib; and
a discharge gas contained in the light emitting cells,
in which the phosphor comprises a borate phosphor having the following formula I:
(Y_{1-x-y-z}GdₓQ_{y}Bi_{z})BO₃
wherein: Q is Eu or Tb; 0≦x<1; 0<y≦0.2; and 0≦z<0.1.

13. The plasma display panel of claim 12, wherein the phosphor is used as a red phosphor, and has the following formula II:
(Y_{1-x-y-z}GdₓEu_{y}Bi_{z})BO₃
wherein: 0≦x≦0.4; 0<y≦0.1; and 0≦z≦0.1.

14. The plasma display panel of claim 12, wherein the phosphor is used as a green phosphor, and has the following formula III:
(Y_{1-x-y-z}GdₓTb_{y}Bi_{z})BO₃
wherein: 0≦x<1; 0<y≦0.2; and 0≦z≦0.1.

15. The plasma display panel of claim 12, wherein the phosphor comprises
(Y_{0.935}Eu_{0.05}Bi_{0.015})BO₃, (Y_{0.645}Gd_{0.3}Eu_{0.05}Bi_{0.005})BO₃, and (Y_{0.64}Gd_{0.3}Eu_{0.05}Bi_{0.01})BO₃.

16. The plasma display panel of claim 12, wherein the phosphor comprises
(Y_{0.93}Tb_{0.06}Bi_{0.01})BO₃, (Y_{0.514}Gd_{0.4}Tb_{0.08}Bi_{0.006})BO₃, and (Y_{0.51}Gd_{0.4}Tb_{0.08}Bi_{0.01})BO₃.
